(19) United States
(12) Patent Application Publication
(10) Pub. No.: US 2025/0227629 A1
(43) Pub. Date: Jul. 10, 2025

(54) METHOD FOR CONTROLLING ANTENNA CONFIGURATION IN ELECTRONIC DEVICE COMPRISING PLURALITY OF ANTENNAS, AND ELECTRONIC DEVICE SUPPORTING SAME

(71) Applicant: Samsung Electronics Co., Ltd., Suwon-si (KR)

(72) Inventors: Wonhyung HEO, Suwon-si (KR); Jungsik MIN, Suwon-si (KR); Taeho KIM, Suwon-si (KR); Daehee PARK, Suwon-si (KR); Sanghyun HAN, Suwon-si (KR)

(21) Appl. No.: 19/091,462

(22) Filed: Mar. 26, 2025

Related U.S. Application Data
(63) Continuation of application No. PCT/KR2023/014888, filed on Sep. 26, 2023.

(30) Foreign Application Priority Data
Sep. 26, 2022 (KR) 10-2022-0121692
Oct. 5, 2022 (KR) 10-2022-0126935

(51) Int. Cl. H04W 52/42; H01Q 3/36; H04W 52/36

(52) U.S. Cl. CPC H04W 52/42; H01Q 3/36; H04W 52/367

(57) ABSTRACT

An electronic device may comprise: a plurality of antennas; antenna tuning circuitry connected to at least one antenna among the plurality of antennas; RF circuitry connected to the at least one antenna tuning circuit; at least one communication processor, comprising processing circuitry, operatively connected to the RF circuitry; and memory storing instructions, wherein the instructions, when executed by at least one communication processor, individually and/or collectively, cause the electronic device to: determine an impedance variation of the at least one antenna connected to the antenna tuning circuitry; based on the determined impedance variation, identify a tune code scenario among a plurality of specified tune code scenarios; check the maximum transmit power of the at least one antenna, corresponding to the identified tune code scenario; and determine a transmit power less than the maximum transmit power, and control the RF circuitry to transmit an RF signal with the determined transmit power.

### CROSS-REFERENCE TO RELATED APPLICATIONS

This application is a continuation of International Application No. PCT/KR2023/014888 designating the United States, filed on Sep. 26, 2023, in the Korean Intellectual Property Receiving Office and claiming priority to Korean Patent Application Nos. 10-2022-0121692, filed on Sep. 26, 2022, and 10-2022-0126935, filed on Oct. 5, 2022, in the Korean Intellectual Property Office, the disclosures of each of which are incorporated by reference herein in their entireties.

### BACKGROUND

### Field

The disclosure relates to a method for controlling a configuration of an antenna in an electronic device and an electronic device supporting the same.

### Description of Related Art

As mobile communication technology evolves, multi-functional portable terminals are commonplace and, to meet increasing demand for radio traffic, vigorous efforts are underway to develop 5G communication systems. To achieve a higher data transmission rate, 5G communication systems are being implemented on higher frequency bands (e.g., a band of GHz to 60 GHz) as well as those used for 3G communication systems and long-term evolution (LTE) communication systems.

For example, to mitigate pathloss on the mmWave band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna.

To transmit a signal from an electronic device to a communication network (e.g., a base station), data generated from a processor or a communication processor in the electronic device may be signal-processed through a radio frequency integrated circuit (RFIC) and radio frequency front-end (RFFE) circuit and then transmitted to the outside of the electronic device through at least one antenna.

### SUMMARY

According to an example embodiment of the disclosure, an electronic device may comprise: a plurality of antennas, antenna tuning circuitry connected to at least one antenna among the plurality of antennas, RF circuitry connected to the antenna tuning circuitry, and at least one communication processor, comprising processing circuitry, operatively connected to the RF circuitry, wherein at least one communication processor, individually and/or collectively, may cause the electronic device to: determine an impedance change in at least one antenna connected to the antenna tuning circuitry among the plurality of antennas; based on the determined impedance change, identify a tune code scenario among a plurality of specified tune code scenarios; identify a maximum transmission power of at least one antenna corresponding to the identified tune code scenario; and determine a transmission power less than the maximum transmission power and control the RF circuitry to transmit an RF signal with the determined transmission power.

According to an example embodiment of the disclosure, a method for controlling a configuration of an antenna in an electronic device including a plurality of antennas may comprise: determining an impedance change in at least one antenna connected to antenna tuning circuitry among the plurality of antennas; based on the determined impedance change, identifying a tune code scenario among a plurality of specified tune code scenarios; identifying a maximum transmission power of at least one antenna corresponding to the identified tune code scenario; and determining a transmission power less than the maximum transmission power and controlling the RF circuitry to transmit an RF signal with the determined transmission power.

According to an example embodiment of the disclosure, in a non-transitory storage medium storing instructions, the instructions may, when executed by at least one circuit of an electronic device, cause the electronic device to perform at least one operation, the at least one operation may comprise: determining an impedance change in at least one antenna connected to antenna tuning circuitry; based on the determined impedance change, identifying a tune code scenario among a plurality of specified tune code scenarios; identifying a maximum transmission power of at least one antenna corresponding to the identified tune code scenario; and determining a transmission power less than the maximum transmission power and controlling the RF circuitry to transmit an RF signal with the determined transmission power.

The disclosure is not limited to the foregoing, and other aspects will be readily appreciated by one skilled in the art from the following detailed description taken in conjunction with the accompanying drawings.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a block diagram illustrating an example configuration of an electronic device for supporting legacy network communication and 5G network communication according to various embodiments;

FIG. 2B is a block diagram illustrating an example configuration of an electronic device for supporting legacy network communication and 5G network communication according to various embodiments;

FIG. 3 is a block diagram illustrating an example configuration of an electronic device according to various embodiments;

FIG. 4A is a block diagram illustrating antenna example tuning circuitry according to various embodiments;

FIG. 4B is a block diagram illustrating example antenna tuning circuitry according to various embodiments;

FIG. 5 is a flowchart illustrating an example method for controlling a configuration of an antenna of an electronic device according to various embodiments;

FIG. 6 is a Smith chart indicating the impedance of an antenna according to various embodiments;

FIG. 7 is a flowchart illustrating an example method for determining the transmission power of an antenna of an electronic device according to various embodiments; and

FIG. 8 is a flowchart illustrating an example method for determining the transmission power of an antenna of an electronic device according to various embodiments.

### DETAILED DESCRIPTION

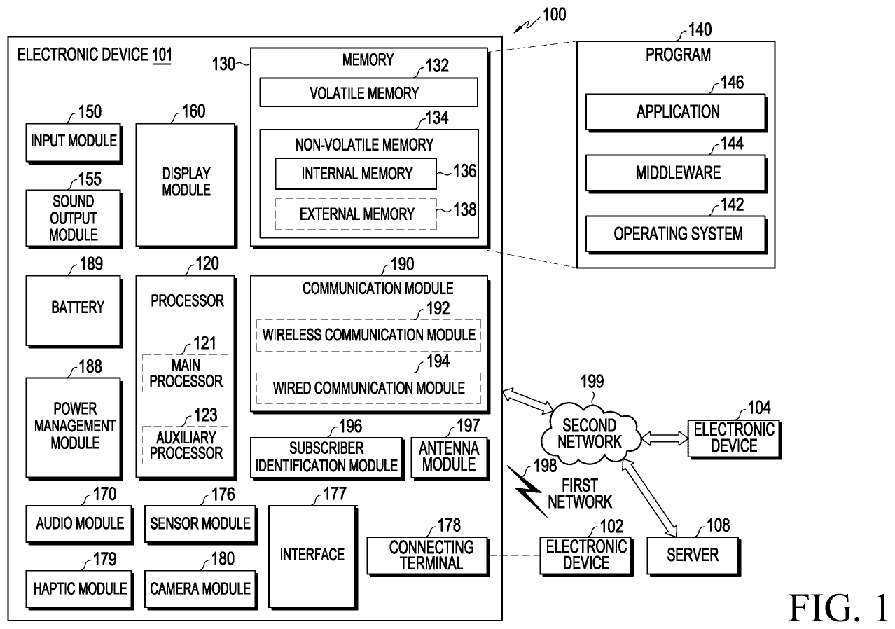

FIG. 1 is a block diagram illustrating an example electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa.

According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

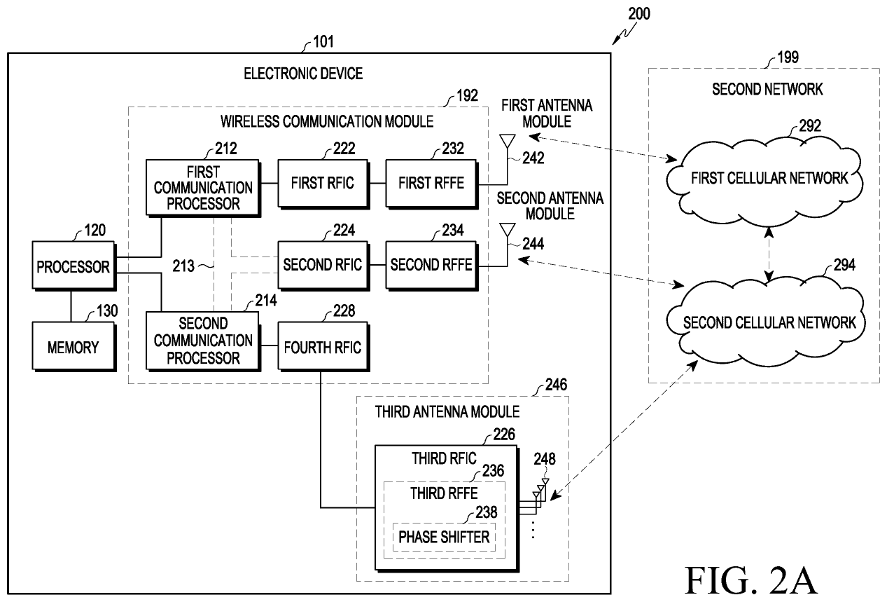

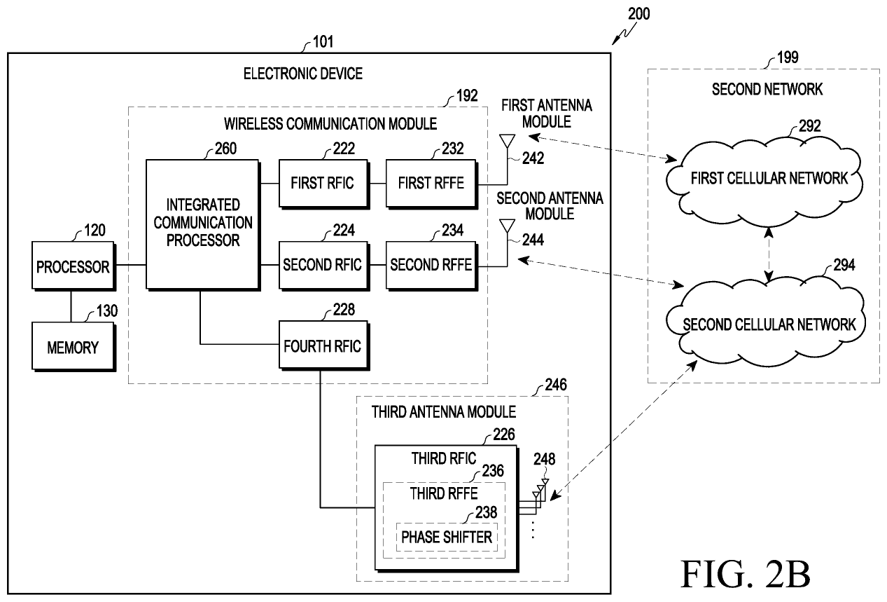

FIG. 2A is a block diagram illustrating an example configuration of an electronic device for supporting legacy network communication and 5G network communication according to various embodiments.

FIG. 2B is a block diagram illustrating an example configuration of an electronic device for supporting legacy network communication and 5G network communication according to various embodiments.

FIG. 2A is a block diagram 200 illustrating an electronic device 101 for supporting legacy network communication and 5G network communication according to an embodiment of the disclosure. Referring to FIG. 2A, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module (e.g., including at least one antenna) 242, a second antenna module (e.g., including at least one antenna) 244, a third antenna module (e.g., including at least one antenna) 246, and antennas 248. The electronic device 101 may further include a processor (e.g., including processing circuitry) 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to an embodiment, the fourth RFIC 228 may be omitted or be included as part of the third RFIC 226.

The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The first communication processor 212 may establish a communication channel of a band that is to be used for wireless communication with the first cellular network 292 or may support legacy network communication via the established communication channel. According to an embodiment, the first cellular network may be a legacy network that includes second generation (2G), third generation (3G), fourth generation (4G), or long-term evolution (LTE) networks. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The second communication processor may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). According to an embodiment, additionally, according to an embodiment, the first communication processor 212 or the second communication processor 214 may establish a communication channel corresponding to another designated band (e.g., about 6 GHz or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to an implementation, the first communication processor 212 may not be directly connected with the second communication processor 214. The first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first CP 212 and the second CP 214 may be implemented in a single chip or a single package. According to an embodiment, the first communication processor 212 or the second communication processor 214, along with the processor 120, an assistance processor 123, or communication module 190, may be formed in a single chip or single package. For example, as shown in FIG. 2B, an integrated communication processor 260 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The integrated communication processor 260 may support all of the functions for communication with the first cellular network 292 and the second cellular network 294.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to an embodiment, when the first RFIC 222 and the second RFIC 224 in FIG. 2A or 2B are implemented as a single chip or a single package, they may be implemented as an integrated RFIC. In this case, the integrated RFIC is connected to the first RFFE 232 and the second RFFE 234 to convert a baseband signal into a signal of a band supported by the first RFFE 232 and/or the second RFFE 234, and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 230 and be accessed by other components (e.g., the processor 120, the first communication processor 212, or the second communication processor 214).

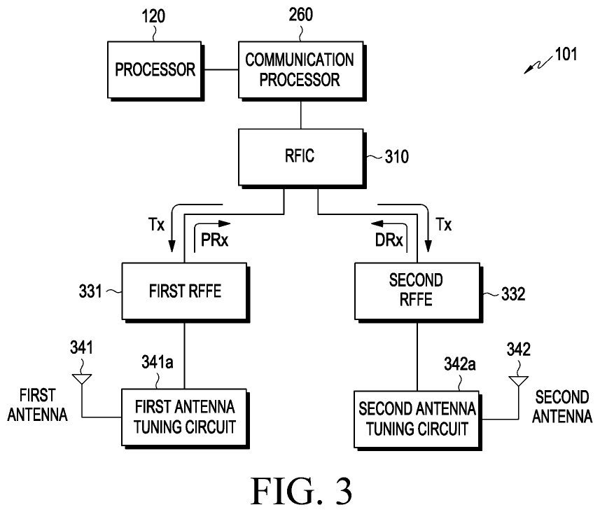

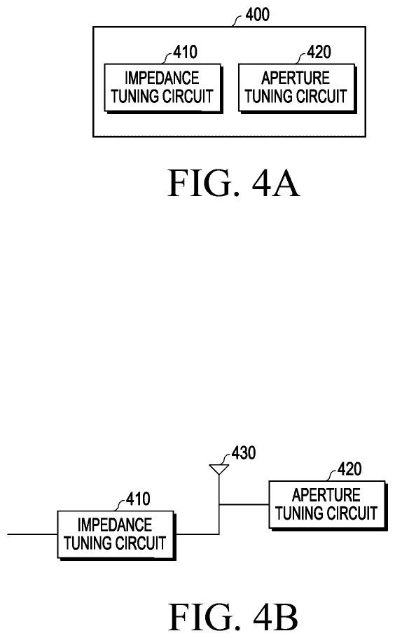

Hereinafter, an example structure and operations of an electronic device 101 according to various embodiments are described with reference to FIGS. 3, 4A, and 4B. Although each drawing of the various embodiments described below illustrates that one communication processor 260 and one RFIC 410 are connected to a plurality of RFFEs 431, 432, 433, and 611 to 640, the various embodiments described below are not limited thereto. For example, in the various example embodiments described below, as illustrated in FIG. 2A or FIG. 2B, a plurality of communication processors 212 and 214 and/or a plurality of RFICs 222, 224, 226, and 228 may be connected to a plurality of RFFEs 431, 432, 433, and 611 to 640.

FIG. 3 is a block diagram illustrating an example configuration of an electronic device according to various embodiments.

According to an embodiment, FIG. 3 illustrates an embodiment of an electronic device including two antennas 341 and 342. Although FIG. 3 illustrates an electronic device including two antennas, according to an embodiment, the electronic device 101 may include three or more antennas. For example, when the electronic device 101 operates as MIMO, the electronic device 101 may receive the signal transmitted from the base station based on the MIMO through the plurality of antennas (e.g., two or more antennas).

Referring to FIG. 3, an electronic device (e.g., the electronic device 101 of FIG. 1) according to an embodiment may include a processor 120, a communication processor 260, an RFIC 310, a first RFFE 331, a second RFEE 332, a first antenna 341, a second antenna 342, first antenna tuning circuitry 341a, or second antenna tuning circuitry 342a. In an embodiment, the first RFFE 331 may be disposed in one area within the housing of the electronic device 101, and the second RFFE 332 may be disposed in another area spaced apart from the one area within the housing of the electronic device 101, but the disclosure is not limited to the arrangement positions.

According to an embodiment, upon transmission, the RFIC 310 may convert a baseband signal generated by the communication processor 260 into a radio frequency (RF) signal used in the communication network. For example, the RFIC 310 may transmit an RF signal used in the first communication network (e.g., a 5G network) or the second communication network (e.g., an LTE network) to the first antenna 341 through the first RFFE 331 and the first antenna tuning circuitry 341a. The RFIC 310 may transmit an RF signal used in the first communication network (e.g., a 5G network) or the second communication network (e.g., an LTE network) to the second antenna 342 through the second RFFE 332 and the second antenna tuning circuitry 342a.

According to an embodiment, the first antenna tuning circuitry 341a may be electrically connected to the first antenna 341, and the second antenna tuning circuitry 342a may be electrically connected to the second antenna 342. In an embodiment, the communication processor 260 may adjust (e.g., tuning) the characteristics of the signal (e.g., the transmission signal Tx) transmitted through each connected antenna and the signal (e.g., the reception signal Rx) received through the antenna by adjusting the setting value of the first antenna tuning circuitry 341a and the setting value of the second antenna tuning circuitry 341a. Detailed embodiments thereof are described below with reference to FIGS. 4A and 4B.

According to an embodiment, the first antenna 341 may be set as a first reception antenna (Rx antenna), and the second antenna 342 may be set as a second reception antenna (Rx antenna). The electronic device 101 may receive and decode the signal transmitted from the base station through the first antenna 341 and/or the second antenna 342. For example, the signal received through the first antenna 341 is the first Rx signal and may be transmitted to the communication processor 260 through the first antenna tuning circuitry 341a, the first RFFE 331, and the RFIC 310. As another example, the signal received through the second antenna 342 is a second Rx signal and may be transmitted to the communication processor 260 through the second antenna tuning circuitry 342a, the second RFFE 332, and the RFIC 310.

According to an embodiment, the first RFFE 331 may include at least one duplexer or at least one diplexer to process the transmission signal Tx and the reception signal Rx together. As another example, the second RFFE 332 may include at least one duplexer or at least one diplexer to process the transmission signal Tx and the reception signal Rx together.

FIG. 4A is a block diagram illustrating example antenna tuning circuitry 400 according to various embodiments.

FIG. 4B is a block diagram illustrating example antenna tuning circuitry 400 according to various embodiments.

According to an embodiment, when the electronic device 101 operates as MIMO, the electronic device 101 may receive a rank for operating as the MIMO from the base station. The electronic device 101 may receive the signal transmitted based on the MIMO from the base station through the first antenna 341 and the second antenna 342. For convenience of description, the signal received through the first antenna 341 may be referred to as a first signal, and the signal received through the second antenna 442 may be referred to as a second signal.

FIGS. 4A and 4B are diagrams illustrating example antenna tuning circuitry according to various embodiments.

Referring to FIG. 4A, antenna tuning circuitry 400 (e.g., the first antenna tuning circuitry 341a or the second antenna tuning circuitry 342a of FIG. 3) according to an embodiment may include at least one impedance tuning circuit 410 and/or at least one aperture tuning circuit 420. The second antenna tuning circuitry 342a may be implemented in the same way as the first antenna tuning circuitry 341a but may be implemented differently. The impedance tuning circuitry 410 according to an embodiment may be configured to perform impedance matching with a network under the control of at least one processor (e.g., the processor 120, the communication processors 212 and 214, and/or the integrated communication processor 260). The aperture tuning circuitry 420 according to an embodiment may change the structure of the antenna by turning on/off the switch under the control of at least one processor.

As shown in FIG. 4B, according to an embodiment, the impedance tuning circuitry 410 may be connected to an RFFE (e.g., the first RFFE 331 or the second RFFE 332 of FIG. 4), and may be connected to the duplexer of the RFFE. The impedance tuning circuitry 410 may be connected to the antenna 430, and the first aperture tuning circuitry (not shown) and the second aperture tuning circuitry (not shown) may be connected to the power rail connecting the impedance tuning circuitry 410 and the antenna 430.

According to an embodiment, the electronic device 101 (e.g., the communication processor 260) may change the setting value of the antenna tuning circuitry 400 according to whether the strength (e.g., reference signal received power (RSRP) or signal to noise ratio (SNR)) of the received signal, or imputation occurs. In an embodiment, the electronic device 101 may control to change the on/off state of the switch included in the antenna tuning circuitry 400 (e.g., the impedance tuning circuitry 410 and/or the aperture tuning circuitry 420) as described above according to a change in the setting value of the antenna tuning circuitry 400.

According to an embodiment, FIG. 4B illustrates that one impedance tuning circuit 410 and one aperture tuning circuit 420 are connected to one antenna, but one of the impedance tuning circuitry 410 or the aperture tuning circuitry 420 may be omitted for one antenna, or a plurality of impedance tuning circuits 410 or a plurality of aperture tuning circuits 420 may be included.

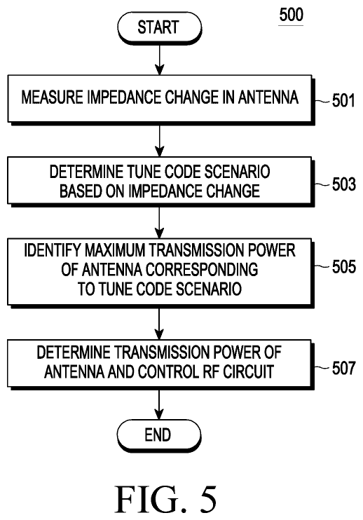

FIG. 5 is a flowchart 500 illustrating an example method for controlling a configuration of an antenna of an electronic device (e.g., the electronic device 101 of FIG. 1) according to various embodiments.

Referring to FIG. 5, in operation 501, in an embodiment, the electronic device 101 may obtain (e.g. determine or measure) an impedance change in an antenna.

In an embodiment, the electronic device (e.g., the electronic device 101 of FIG. 1) (e.g., the first communication processor 212 of FIG. 2A, the second communication processor 214 of FIG. 2A, the integrated communication processor 260 of FIG. 2B, or the communication processor 260 of FIG. 3) may determine (or, measure) a change in impedance of an antenna (e.g., the first antenna 341a or the second antenna 342a of FIG. 3) connected to the antenna tuning circuitry (e.g., the first antenna tuning circuitry 341a or the second antenna tuning circuitry 342a of FIG. 3 or the antenna tuning circuitry 400 of FIG. 4A). For example, using a mismatch sensor (not shown) electrically connected to the antenna, the electronic device 101 may monitor whether an implantation occurs in the antenna every hundreds of milliseconds (ms). In an embodiment, the impedance of the antenna may change due to the user's grip on the electronic device 101. In an embodiment, a situation in which the performance of signal transmission/reception of an antenna is deteriorated due to the user's grip may be referred to as a “hand-effect” or a “finger-effect”. In an embodiment, the electronic device 101 may reduce the mismatch loss inside the antenna by controlling a plurality of switches included in the impedance tuning circuitry (e.g., the impedance tuning circuitry 410 of FIG. 4A). The electronic device 101 may enhance the total radiated power (TRP) of the antenna based on impedance matching of the antenna tuning circuitry 400. In an embodiment, a method of performing impedance matching based on the antenna's impedance monitoring may be referred to as “closed loop antenna tuning”.

In operation 503, in an embodiment, the electronic device 101 may determine a tune code scenario based on the impedance change.

In an embodiment, the electronic device 101 may determine any one of a plurality of predetermined (e.g., specified) tune code scenarios based on the determined (or, measured) impedance change. In an embodiment, the tune code scenario may include a tune code for antenna impedance matching and a ground logic for controlling the antenna beam radiated by the antenna. In an embodiment, the electronic device 101 may control the RF circuitry (e.g., the first RFFE 331 or the second RFFE 332 of FIG. 3) so that the impedance tuning circuitry 410 performs antenna impedance matching based on the tune code corresponding to the determined tune code scenario. The electronic device 101 may control the RF circuitry so that a plurality of ground switches (not shown) electrically connected to the antenna change the operation state based on the ground logic corresponding to the determined tune code scenario. The electronic device 101 may control the antenna beam radiated by the antenna by changing the operation states of the ground switches. In an embodiment, the specific subsistence rate (SAR) value may be variously changed according to the shape of the antenna beam.

TABLE 1

| Tune code | Tune | | 5 mm | | | |
|---|---|---|---|---|---|---|
| scenario | code | X-GND | SAR | Pₗᵢₘᵢₜ | TRP(GRIP) | TRP(Table) |
| 1 | 1 | 0 | 1 | 20 | 15 | 10 |
| 2 | 2 | 0 | 0.95 | 20 | 14.7 | 10.2 |
| 3 | 3 | 0 | 0.9 | 20 | 14.6 | 10.4 |
| 4 | 4 | 0 | 0.9 | 20 | 14.5 | 10.8 |
| 5 | 5 | 0 | 0.87 | 20 | 14.3 | 12 |
| 6 | 6 | 0 | 0.8 | 20 | 14 | 13 |
| 7 | 7 | 0 | 0.7 | 21 | 13 | 13.5 |
| 8 | 8 | 0 | 0.6 | 22 | 12 | 14 |
| 9 | 9 | 0 | 0.5 | 23 | 11 | 14.5 |
| 10 | 10 | 0 | 0.4 | 23 | 10 | 15 |
| 11 | 1 | 8 | 0.8 | 21 | 15 | 13 |
| 12 | 2 | 8 | 0.78 | 21.5 | 14.9 | 13.2 |
| 13 | 3 | 8 | 0.75 | 22 | 14.8 | 13.5 |
| 14 | 4 | 8 | 0.7 | 22.5 | 14.5 | 12 |
| 15 | 5 | 8 | 0.65 | 23 | 14 | 14.7 |

In an embodiment, referring to Table 1, the electronic device 101 may pre-store a lookup table related to the maximum transmission power Pₗᵢₘᵢₜ of the antenna corresponding to each of the plurality of tune code scenarios. In an embodiment, the electronic device 101 may pre-store a lookup table related to the maximum transmission power corresponding to the tune code scenario for each frequency band. Referring to Table 1, X-GND may be a value indicating the operation state of the plurality of ground switches. When the maximum transmission power of the antenna is 20 dBm, the TRP (GRIP) may be a gain of the antenna under a grip condition for the electronic device 101. In an embodiment, the grip condition may be a case in which the grip sensor (e.g., the sensor module 176 of FIG. 1) is turned on, and an impedance change in the antenna corresponds to an impedance change in the pre-stored grip condition. TRP (Table) may be an antenna gain under a table condition when the maximum transmission power of the antenna is 20 dBm. In an embodiment, the event related to the electronic device 101 may further include an ear jack condition or a receiver condition. In an embodiment, the table condition may be a case in which the grip sensor is turned on, and a change in impedance of the antenna does not correspond to the grip condition for the electronic device 101, such as a condition in which the electronic device 101 is placed on the table. The values disclosed in Table 1 may be variously changed according to an embodiment of the present disclosure and are not limited to those disclosed in Table 1. In an embodiment, each maximum transmission power may be predetermined based on the SAR value corresponding to each tune code scenario. For example, the maximum transmission power of the antenna may be configured to be predetermined according to the SAR value measured based on the antenna beam radiated from the antenna, corresponding to each of the plurality of tune code scenarios. The SAR may be a time average SAR (TAS) or an instantaneous SAR measured at a distance of 5 millimeters (mm). For example, the electronic device 101 may output the TRP value as 15 by determining the number 1 tune code scenario or number 11 tune code scenario based on measuring the impedance change corresponding to the grip condition for the electronic device 101. The electronic device 101 may output the TRP value as 15 by determining the number 10 tune code scenario based on measuring the impedance change corresponding to the grip condition for the electronic device 101.

In operation 505, in an embodiment, the electronic device 101 may identify the maximum transmission power of the antenna corresponding to the tune code scenario.

In an embodiment, the electronic device 101 may identify the maximum transmission power of the antenna corresponding to the determined tune code scenario based on the lookup table. For example, the electronic device 101 may identify that the maximum transmission power of the antenna is 20 dBm based on determining the number 1 tune code scenario under the grip condition. The electronic device 101 may identify that the maximum transmission power of the antenna is 21 dBm based on determining the number 11 tune code scenario under the grip condition. The electronic device 101 may control the RF circuitry so that the transmission power of the antenna has a value exceeding 20 dBm based on the SAR value without fixing the maximum transmission power of the antenna to 20 dBm, which is the backoff power under the grip condition. The electronic device 101 allows the radiated antenna beam to meet a preset reference SAR value and enhances the TRP of the antenna by controlling the maximum transmission power of the antenna to exceed the backoff power in response to at least some tune code scenarios. The backoff power in the grip condition may be variously changed according to the communication environment, and is not limited to the above-described examples.

In operation 507, in an embodiment, the electronic device 101 may determine the transmission power of the antenna and control the RF circuitry.

In an embodiment, the electronic device 101 may determine a transmission power equal to or less than the identified maximum transmission power and control the RF circuitry such that an RF signal with the determined transmission power. The electronic device 101 may determine the transmission power of the antenna exceeding the fixed backoff power based on the maximum transmission power predetermined corresponding to the tune code scenario. For example, if the antenna's maximum transmission power is fixed to 20 dBm, the antenna's TRP may exhibit 15 dBm performance under the table condition, based on the number 10 tune code scenario. In an embodiment, referring to Table 1, the maximum transmission power of the antenna corresponding to the number 10 tune code scenario may be predetermined as 23 dBm, based on an SAR value of 0.4. The electronic device 101 may enhance the TRP value of the antenna to 18 dBm by determining the transmission power of the antenna based on the maximum transmission power of 23 dBm corresponding to the number 10 tune code scenario under the table condition. The electronic device 101 may enhance the throughput (TP) of the antenna by controlling the transmission power of the antenna according to the tune code scenario.

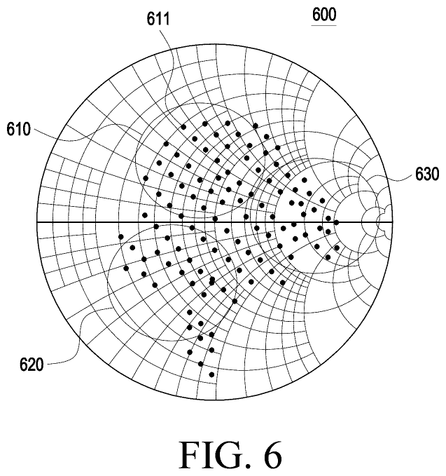

FIG. 6 is a Smith chart 600 indicating the impedance of an antenna according to various embodiments.

In an embodiment, the electronic device (e.g., the electronic device 101 of FIG. 1) may perform impedance matching by determining any one of a plurality of preset tune codes based on a change in impedance of the antenna. The electronic device 101 may determine the operation state of a plurality of switches included in the impedance tuning circuitry (e.g., the impedance tuning circuitry 410 of FIG. 4) and/or the capacitance of the variable capacitor based on the determined tune code. For example, referring to FIG. 6, the electronic device 101 may perform impedance matching based on any one tune code 611 among a plurality of tune codes included in a first area 610 under a free space condition. The electronic device 101 may perform impedance matching based on any one of a plurality of tune codes included in a second area 620 under the grip condition. The electronic device 101 may perform impedance matching based on any one of a plurality of tune codes included in a third area 630 under a universal serial bus (USB) connect condition. In an embodiment, the electronic device 101 may set the maximum transmission power of the antenna to exceed the backoff power for a plurality of tune codes included in an area other than the first area 610. The electronic device 101 may set the maximum transmission power of the antenna to differ corresponding to the tune code so that the antenna beam meets a preset SAR condition and may enhance the throughput of the antenna.

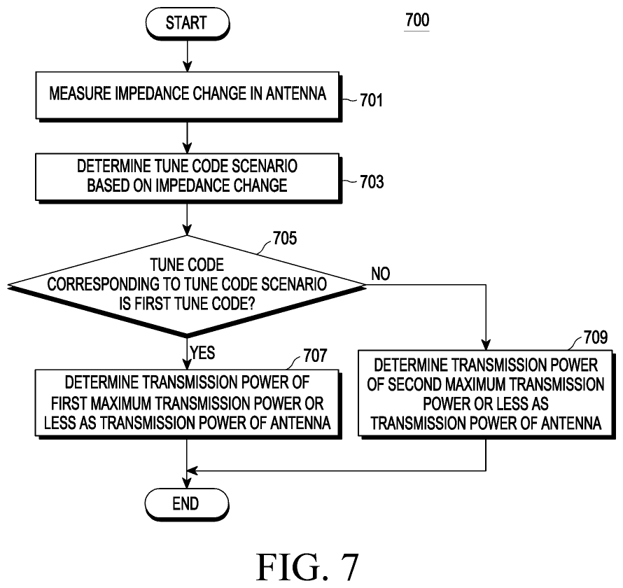

FIG. 7 is a flowchart 700 illustrating an example method for determining the transmission power of an antenna of an electronic device (e.g., the electronic device 101 of FIG. 1) according to various embodiments.

Referring to FIG. 7, in an embodiment, the electronic device 101 (e.g., the electronic device 101 of FIG. 1) (e.g., the first communication processor 212 of FIG. 2A, the second communication processor 214 of FIG. 2A, the integrated communication processor 260 of FIG. 2B, or the communication processor 260 of FIG. 3) may determine (e.g., obtain or measure) the impedance change in the antenna. Since operation 701 is at least partially the same or similar to the operation 501, a detailed description thereof may not be repeated here.

In operation 703, in an embodiment, the electronic device 101 may determine a tune code scenario based on the impedance change. Since operation 703 is at least partially the same or similar to the operation 503, a detailed description thereof may not be repeated here.

In operation 705, in an embodiment, the electronic device 101 may identify whether the tune code is the first tune code.

In an embodiment, the electronic device 101 may identify whether the tune code corresponding to the determined tune code scenario is the number 1 tune code. For example, referring back to Table 1, the electronic device 101 may identify that the tune code corresponding to the number 1 tune code scenario is the number 1 tune code under the grip condition. Referring to Table 1, the electronic device 101 may identify that the tune code corresponding to the number 7 tune code scenario is the number 7 tune code.

In operation 707, in an embodiment, when the tune code corresponding to the determined tune code scenario is the number 1 (e.g., first) tune code, the electronic device 101 may determine the transmission power equal to or less than the first maximum transmission power as the transmission power of the antenna.

In an embodiment, referring back to Table 1, when the tune code corresponding to the determined number 1 tune code scenario is the number 1 tune code, the electronic device 101 may determine the transmission power of 20 dBm or less as the transmission power of the antenna. The first maximum transmission power of the antenna is not limited to Table 1, and may be predetermined to have any one value among 18 dBm to 20 dBm.

In operation 709, in an embodiment, when the tune code corresponding to the determined tune code scenario is the second tune code (e.g., not the first tune code), the electronic device 101 may determine the transmission power equal to or less than the second maximum transmission power as the transmission power of the antenna.

In an embodiment, the second maximum transmission power may be predetermined to have a value larger than the first maximum transmission power. For example, referring to Table 1, the electronic device 101 may determine the transmission power of 21 dBm or less as the transmission power of the antenna when the tune code corresponding to the determined number 7 tune code scenario is the number 7 tune code. The second maximum transmission power of the antenna is not limited to Table 1, and may be predetermined to have any one value among 21 dBm to 24 dBm. The electronic device 101 may determine a value less than or equal to the maximum transmission power as the transmission power of the antenna based on the maximum transmission power of the antenna differently determined according to the tune code in the same frequency band. The electronic device 101 meets a preset SAR criterion without fixing the maximum transmission power of the antenna, and may enhance the throughput of the antenna.

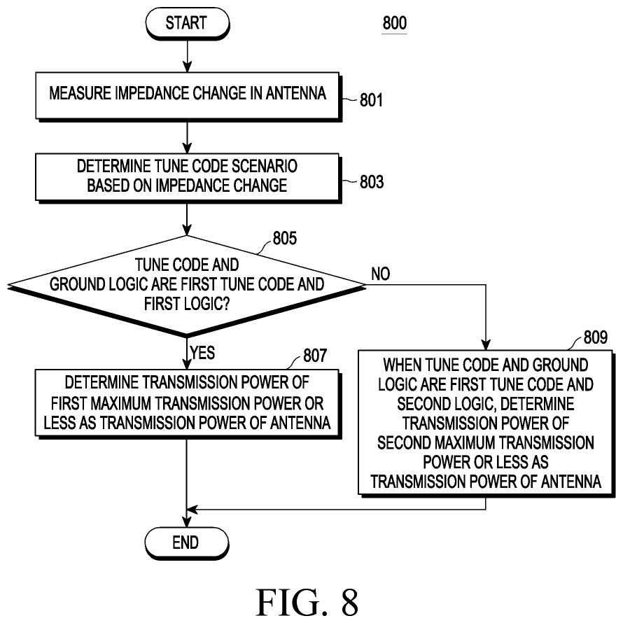

FIG. 8 is a flowchart 800 illustrating an example method for determining the transmission power of an antenna of an electronic device (e.g., the electronic device 101 of FIG. 1) according to various embodiments.

Referring to FIG. 8, in operation 801, in an embodiment, the electronic device 101 (e.g., the electronic device 101 of FIG. 1) (e.g., the first communication processor 212 of FIG. 2A, the second communication processor 214 of FIG. 2A, the integrated communication processor 260 of FIG. 2B, or the communication processor 260 of FIG. 3) may determine (e.g., obtain or measure) the impedance change in the antenna. Since operation 801 is at least partially the same or similar to the operation 501, a detailed description thereof may not be repeated here.

In operation 803, in an embodiment, the electronic device 101 may determine a tune code scenario based on the impedance change. Since operation 803 is at least partially the same or similar to the operation 503, a detailed description thereof may not be repeated here.

In operation 805, in an embodiment, the electronic device 101 may identify whether the tune code and the ground logic are the first tune code and the first logic.

In an embodiment, the electronic device 101 may identify whether the tune code and the ground logic corresponding to the determined tune code scenario are the number 1 tune code and 0, respectively. For example, referring back to Table 1, the electronic device 101 may identify that the tune code corresponding to the number 1 tune code scenario is the number 1 tune code and the value of ground logic is zero under the grip condition. Referring to Table 1, the electronic device 101 may identify that the tune code corresponding to the number 11 tune code scenario is the number 1 tune code and the value of the ground logic is 8.

In operation 807, in an embodiment, when the tune code and the ground logic are the first tune code and the first logic, the electronic device 101 may determine the transmission power equal to or less than the first maximum transmission power as the transmission power of the antenna.

In an embodiment, referring to Table 1, the electronic device 101 may determine transmission power of 20 dBm or less as the transmission power of the antenna when the tune code corresponding to the determined number 1 tune code scenario is the number 1 tune code and the value of the ground logic is 0. The first maximum transmission power of the antenna is not limited to Table 1, and may be predetermined to have any one value among 18 dBm to 20 dBm.

In operation 809, in an embodiment, when the tune code and the ground logic are the first tune code and the second logic, the electronic device 101 may determine the transmission power equal to or less than the second maximum transmission power as the transmission power of the antenna.

In an embodiment, the second maximum transmission power may be predetermined to have a value larger than the first maximum transmission power. For example, referring to Table 1, the electronic device 101 may determine the transmission power of 21 dBm or less as the transmission power of the antenna if the tune code corresponding to the determined tune code scenario is number 1 and the ground logic value is 8. The second maximum transmission power of the antenna is not limited to Table 1, and may be predetermined to have any one value among 21 dBm to 24 dBm. The electronic device 101 may determine a value less than or equal to the maximum transmission power of the antenna based on the maximum transmission power of the antenna differently determined according to the tune code and ground logic in the same frequency band. The electronic device 101 meets a preset SAR criterion without fixing the maximum transmission power of the antenna, and may enhance the throughput of the antenna.

According to an example embodiment of the disclosure, an electronic device may comprise: a plurality of antennas, antenna tuning circuitry connected to at least one antenna among the plurality of antennas, RF circuitry connected to the antenna tuning circuitry, at least one communication processor, comprising processing circuitry, operatively connected to the RF circuitry, and memory storing instructions, wherein the instructions, when executed by at least one communication processor, individually and/or collectively, may cause the electronic device to: determine an impedance change in at least one antenna connected to the antenna tuning circuitry among the plurality of antennas; based on the determined impedance change, identify a tune code scenario among a plurality of specified tune code scenarios; identify a maximum transmission power of the at least one antenna corresponding to the identified tune code scenario; and determine a transmission power less than the maximum transmission power and control the RF circuitry to transmit an RF signal with the determined transmission power.

In an example embodiment, the identified tune code scenario may include a tune code for impedance matching of the at least one antenna and a ground logic for controlling an antenna beam radiated by the at least one antenna.

In an example embodiment, the maximum transmission power of the at least one antenna may be configured to be specified based on a specific absorption rate SAR value measured based on an antenna beam radiated by the at least one antenna corresponding to one of the plurality of tune code scenarios.

In an example embodiment, the instructions, when executed by at least one communication processor, individually and/or collectively, may cause the electronic device to determine a transmission power less than a first maximum transmission power as the transmission power of the at least one antenna based on a tune code corresponding to the identified tune code scenario being a first tune code.

In an example embodiment, the instructions, when executed by at least one communication processor, individually and/or collectively, may cause the electronic device to determine a transmission power less than a second maximum transmission power as the transmission power of the at least one antenna based on a tune code corresponding to the determined tune code scenario being a second tune code.

In an example embodiment, the second maximum transmission power may be determined to have a value larger than the first maximum transmission power.

In an example embodiment, the first maximum transmission power may be determined to have a value between 18 dBm and 20 dBm.

In an example embodiment, the second maximum transmission power may be determined to have a value between 21 dBm and 24 dBm.

In an example embodiment, the instructions, when executed by at least one communication processor, individually and/or collectively, may cause the electronic device to: determine a transmission power less than a first maximum transmission power as the transmission power of the at least one antenna based on a tune code corresponding to the identified tune code scenario being a first tune code and a ground logic corresponding to the identified tune code scenario being a first logic.

In an example embodiment, at least one communication processor, individually and/or collectively, may be configured to determine a transmission power less than a second maximum transmission power as the transmission power of the at least one antenna based on a tune code corresponding to the identified tune code scenario being a first tune code and a ground logic corresponding to the identified tune code scenario being a second logic.

According to an example embodiment of the disclosure, a method for controlling a configuration of an antenna in an electronic device including a plurality of antennas may comprise: determining an impedance change in at least one antenna connected to an antenna tuning circuitry among the plurality of antennas; based on the determined impedance change, identifying a tune code scenario among a plurality of specified tune code scenarios; identifying a maximum transmission power of the at least one antenna corresponding to the identified tune code scenario; and determining a transmission power less than the maximum transmission power and controlling RF circuitry to transmit an RF signal with the determined transmission power.

In an example embodiment, the identified tune code scenario may include a tune code for impedance matching of the at least one antenna and a ground logic for controlling an antenna beam radiated by the at least one antenna.

In an example embodiment, the maximum transmission power of the at least one antenna may be determined based on a specific absorption rate (SAR) value measured based on an antenna beam radiated by the at least one antenna corresponding one of the plurality of tune code scenarios.

In an example embodiment, the method may further comprise determining a transmission power less than a first maximum transmission power as the transmission power of the at least one antenna based on a tune code corresponding to the identified tune code scenario being a first tune code.

In an example embodiment, the method may comprise determining a transmission power less than a second maximum transmission power as the transmission power of the at least one antenna based on a tune code corresponding to the identified tune code scenario being a second tune code.

In an example embodiment, the second maximum transmission power may be determined to have a value larger than the first maximum transmission power.

In an example embodiment, the first maximum transmission power may be determined to have a value between 18 dBm and 20 dBm.

In an example embodiment, the second maximum transmission power may be determined to have a value between 21 dBm and 24 dBm.

In an example embodiment, the method may further comprise determining a transmission power less than a first maximum transmission power as the transmission power of the at least one antenna based on a tune code corresponding to the identified tune code scenario being a first tune code and a ground logic corresponding to the identified tune code scenario being a first logic.

In an example embodiment, the method may further comprise determining a transmission power less than a second maximum transmission power as the transmission power of the at least one antenna based on a tune code corresponding to the identified tune code scenario being a first tune code and a ground logic corresponding to the identified tune code scenario being a second logic.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. Further, the structure of the data used in various embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a CD-ROM or a DVD).

Example embodiments of the disclosure have been described above. The above-described embodiments are merely examples, and it will be appreciated by one skilled in the art various changes may be made thereto without departing from the scope of the present disclosure, including the appended claims and their equivalents. Therefore, the disclosed embodiments should be considered from an illustrative, rather than a limiting, point of view. It will also be understood that any of the embodiment(s) described herein may be used in conjunction with any other embodiment(s) described herein.

What is claimed is:

1. An electronic device, comprising:
a plurality of antennas;
antenna tuning circuitry connected to at least one antenna among the plurality of antennas;
RF circuitry connected to the antenna tuning circuitry;
at least one communication processor, comprising processing circuitry, operatively connected to the RF circuitry; and
memory storing instructions that, when executed by at least one communication processor, individually and/or collectively, cause the electronic device to:
determine an impedance change in at least one antenna connected to the antenna tuning circuitry among the plurality of antennas;
based on the determined impedance change, identify a tune code scenario among a plurality of specified tune code scenarios;
identify a maximum transmission power of the at least one antenna corresponding to the identified tune code scenario; and
determine a transmission power less than the maximum transmission power and control the RF circuitry to transmit an RF signal with the determined transmission power.

2. The electronic device of claim 1, wherein the identified tune code scenario includes a tune code for impedance matching of the at least one antenna and a ground logic for controlling an antenna beam radiated by the at least one antenna.

3. The electronic device of claim 1, wherein the maximum transmission power of the at least one antenna is determined based on a specific absorption rate (SAR) value measured based on an antenna beam radiated by the at least one antenna corresponding one of the plurality of tune code scenarios.

4. The electronic device of claim 1, wherein the instructions, when executed by at least one communication processor, individually and/or collectively, cause the electronic device to determine a transmission power less than a first maximum transmission power as the transmission power of the at least one antenna based on a tune code corresponding to the identified tune code scenario being a first tune code.

5. The electronic device of claim 1, wherein the instructions, when executed by at least one communication processor, individually and/or collectively, cause the electronic device to determine a transmission power less than a second maximum transmission power as the transmission power of the at least one antenna based on a tune code corresponding to the determined tune code scenario being a second tune code.

6. The electronic device of claim 1, wherein the second maximum transmission power is determined to have a value greater than the first maximum transmission power.

7. The electronic device of claim 1, wherein the first maximum transmission power is determined to have a value between 18 dBm and 20 dBm.

8. The electronic device of claim 1, wherein the second maximum transmission power is determined to have a value between 21 dBm and 24 dBm.

9. The electronic device of claim 1, wherein the instructions, when executed by at least one communication processor, individually and/or collectively, cause the electronic device to determine a transmission power less than a first maximum transmission power as the transmission power of the at least one antenna based on a tune code corresponding to the identified tune code scenario being a first tune and a ground logic corresponding to the identified tune code scenario being a first logic.

10. The electronic device of claim 1, wherein the instructions, when executed by at least one communication processor, individually and/or collectively, cause the electronic device to determine a transmission power less than a second maximum transmission power as the transmission power of the at least one antenna based on a tune code corresponding to the identified tune code scenario being a first tune code and a ground logic corresponding to the identified tune code scenario being a second logic.

11. A method for controlling a configuration of an antenna in an electronic device including a plurality of antennas, the method comprising:
determining an impedance change in at least one antenna connected to antenna tuning circuitry among the plurality of antennas;
based on the measured impedance change, identifying a tune code scenario among a plurality of specified tune code scenarios;
identifying a maximum transmission power of the at least one antenna corresponding to the identified tune code scenario; and
determining a transmission power less than the maximum transmission power and controlling RF circuitry to transmit an RF signal with the determined transmission power.

12. The method of claim 11, wherein the identified tune code scenario includes a tune code for impedance matching of the at least one antenna and a ground logic for controlling an antenna beam radiated by the at least one antenna.

13. The method of claim 11, wherein the maximum transmission power of the at least one antenna is determined based on a specific absorption rate (SAR) value measured based on an antenna beam radiated by the at least one antenna corresponding one of the plurality of tune code scenarios.

14. The method of claim 11, further comprising determining a transmission power less than a first maximum transmission power as the transmission power of the at least one antenna based on a tune code corresponding to the identified tune code scenario being a first tune code.

15. The method of claim 11, further comprising determining a transmission power less than a second maximum transmission power as the transmission power of the at least one antenna based on a tune code corresponding to the identified tune code scenario being a second tune code.

16. A non-transitory computer-readable recording medium storing instructions that, when executed by at least one processor of an electronic device, individually and/or collectively, cause the electronic device to:
determine an impedance change in at least one antenna connected to the antenna tuning circuitry among the plurality of antennas,
based on the determined impedance change, identify a tune code scenario among a plurality of specified tune code scenarios,
identify a maximum transmission power of the at least one antenna corresponding to the identified tune code scenario, and
determine a transmission power less than the maximum transmission power and control the RF circuitry to transmit an RF signal with the determined transmission power.

17. The recording medium of claim 16, wherein the identified tune code scenario includes a tune code for impedance matching of the at least one antenna and a ground logic for controlling an antenna beam radiated by the at least one antenna.

18. The recording medium of claim 16, wherein the maximum transmission power of the at least one antenna is determined based on a specific absorption rate (SAR) value measured based on an antenna beam radiated by the at least one antenna corresponding one of the plurality of tune code scenarios.

19. The recording medium of claim 16, wherein the instructions, when executed by at least one communication processor, individually and/or collectively, cause the electronic device to determine a transmission power less than a first maximum transmission power as the transmission power of the at least one antenna based on a tune code corresponding to the identified tune code scenario being a first tune code.

20. The recording medium of claim 16, wherein the instructions, when executed by at least one communication processor, individually and/or collectively, cause the electronic device to determine a transmission power less than a second maximum transmission power as the transmission power of the at least one antenna based on a tune code corresponding to the determined tune code scenario being a second tune code.
